(19) United States
(12) Patent Application Publication
(10) Pub. No.: US 2017/0203542 A1
(43) Pub. Date: Jul. 20, 2017

(54) NONWOVEN COMPOSITE INCLUDING NATURAL FIBER WEB LAYER AND METHOD OF FORMING THE SAME

(71) Applicant: FIRST QUALITY NONWOVENS, INC., Great Neck, NY (US)

(72) Inventors: Karthik Ramaratnam, Anderson, SC (US); John C. Parsons, Dallas, PA (US); Peter Zajaczkowski, Greenville, SC (US)

(21) Appl. No.: 15/407,989

(22) Filed: Jan. 17, 2017

Related U.S. Application Data
(60) Provisional application No. 62/279,187, filed on Jan. 15, 2016.

(51) Int. Cl. B32B 7/08; B32B 5/26; B32B 5/02; D04H 1/492; D04H 1/70

(52) U.S. Cl. CPC B32B 7/08; D04H 1/492; D04H 1/70; B32B 5/022; B32B 5/26; B32B 2307/54

(57) ABSTRACT

A composite structure including at least one natural fiber web layer and at least one nonwoven web layer. In an exemplary embodiment, the natural fiber web layer is made of cotton fibers and the nonwoven web layer is a spunbond or spunmelt layer. The composite structure may be used to form components of an absorbent article, such as top sheets or back sheets of a diaper.

### FIELD OF THE INVENTION

The present disclosure generally relates to composite structures, and in particular to nonwoven composite structures intended for use in absorbent articles.

### BACKGROUND

Nonwoven composite webs made with a combination of various natural fibers and synthetic fibers are known in the conventional art for use in mainly absorbent (hydrophilic) products or product components. Synthetic fibers and wood fiber combination is prevalent in wipes, while use of natural fibers such as bagasse, kenaf, hemp and ramie combined with synthetic fibers is known to be used in automotive nonwoven composite materials. Cotton in particular is a common fiber that has a widespread use in the textile industry with some limited use in wipes and absorbent products such as absorbent pads and acquisition distribution layers in a diaper. This is mainly due to the fiber's superior softness properties and its hydrophilic characteristics. Despite the superior softness and absorbent characteristics of cotton fiber, the high water wetting (hydrophilic) properties of cotton fiber limits its use in producing a hydrophobic diaper backsheet and/or a topsheet with limited hydrophilicity. Additionally, cotton containing non-woven fabrics are carded spunlaced materials and therefore have less strength compared to conventional spunbond/spunmelt fabrics. Therefore the use of natural fiber such as cotton is limited in diaper applications for both topsheet and backsheet, due to the lower overall fabric strength and sub-optimal abrasion resistance properties compared to conventional spunbond/spunmelt fabrics. In addition to cotton, other natural fibers such as wood fibers and plant fibers find limited use in diaper topsheets and backsheets.

### SUMMARY OF THE INVENTION

In this invention, a base spunbond/spunmelt fabric is combined with a carded or pre-formed web containing natural fibers using a hydroentangling step and the resultant web is dried to form the composite web. An object of the present invention is to provide a natural fiber containing topsheet/backsheet, more specifically a cotton fiber with superior strength, abrasion resistance, tactile feel, and wettability characteristics (hydrophilic/phobic) that can be controlled based on end-use. These properties can be achieved by controlling a variety of process parameters such as the fiber choice, use of chemical additives, composite web manufacturing method and its processing conditions.

Another object of the present invention is to allow for the incorporation of natural fibers at low basis weight (e.g., 10 to 20 gsm), into a composite material with the total basis weight ranging from 25 to 100 gsm. Using roll goods with suitable natural fiber content allows for production of composite materials at commercial production speeds ranging from 500 to 1000 mpm, while a traditional carded spunlace or airlaid lines are limited to production speeds well under 500 mpm.

Another object of the present invention is to provide a wipe product made of a combination of a natural fiber web and spunbond/spunmelt webs.

A composite structure according to an exemplary embodiment of the present invention comprises at least one natural fiber web layer and at least one nonwoven web layer.

According to an exemplary embodiment of the present invention, a method for making a composite structure includes: providing at least one natural fiber web layer and at least one nonwoven web layer; and hydroentangling the at least one natural fiber web layer with the at least one nonwoven web layer.

In at least one embodiment, the at least one nonwoven web layer is a spunbond or spunmelt web layer.

In at least one embodiment, the at least one nonwoven web layer, which is a spunbond or spunmelt web layer has a philic in-melt additive.

In at least one embodiment, the at least one nonwoven web layer comprises polypropylene, polyethylene, polyester, nylon or PLA.

In at least one embodiment, the at least one natural fiber web layer has adjustable wettability characteristics.

In at least one embodiment, the at least one natural fiber web layer is completely hydrophobic.

In at least one embodiment, the at least one natural fiber web layer is completely hydrophilic.

In at least one embodiment, the at least one natural fiber web layer is adjusted to be at least partially hydrophobic.

In at least one embodiment, the at least one natural fiber web layer comprises at least one of abaca, coir, cotton, flax, hemp, jute, ramie, sisal, alpaca wool, angora wool, camel hair, cashmere, mohair, silk, wool, hardwood, softwood, or elephant grass fibers.

In at least one embodiment, the at least one natural fiber web layer comprises cotton fibers and/or cotton linters.

In at least one embodiment, the overall cotton content of the composite product may contain up to 80%, more preferably in the 4 to 55% range.

In at least one embodiment, the at least one natural fiber web layer comprises pulp fibers, hardwood and/or softwood fibers.

In at least one embodiment, the at least one natural fiber web layer may be a preformed web in the form of a rolled good that is unwound on the composite web line to make the composite product.

In at least one embodiment, the at least one natural fiber web layer present in the form of a rolled good may be made up of 100% wood fibers.

In at least one embodiment, the at least one natural fiber web layer present in the form of a rolled good may be made up of 100% cotton fibers, more specifically cotton linters.

In at least one embodiment, the at least one natural fiber web layer present in the form of a rolled good may be made up of a combination of wood fibers and cotton fibers, more specifically cotton linters. Wood fiber content may vary from 0 to 100%, and cotton fiber content may vary from 0 to 100%.

In at least one embodiment, the at least one natural fiber web layer present in the form of a rolled good may be made up of a combination of wood fibers and hemp fibers. Wood fiber content may vary from 0 to 100% and hemp fiber content may vary from 0 to 100%.

In at least one embodiment, the at least one natural fiber web layer comprises a blend of natural fibers and synthetic staple fibers. The natural fiber content in this natural fiber web layer may be in the range of 5 to 100%, more preferably from 5 to 80%. The synthetic staple fiber content in this natural fiber web layer may be in the range of 5 to 100%, more preferably from 5 to 80%.

In at least one embodiment, the at least one natural fiber web layer and the at least one nonwoven web layer are subjected to a hydroentangling process to form the composite structure.

In at least one embodiment, the composite web may be plain, patterned or aperture. The patterning or aperturing process is performed using the hydroentangling process.

In at least one embodiment, fluid pressure used in the hydroentangling process is within a range of 10 to 200 bars, with a target hydroentangling energy flux range of 0.05 to 1 Kw-hr/kg.

In at least one embodiment, fluid pressure used in the hydroentangling process is within a range of 20 to 100 bars, with a target hydroentangling energy flux range of 0.05 to 1 Kw-hr/kg.

In at least one embodiment, the use of a hydrophilic natural fiber which is subjected to a hydroentangling process to produce a composite non-woven web may have pronounced patterned structures with higher bulk, due to the tendency of the hydrophilic natural fibers to move to the raised areas of the pattern.

In at least one embodiment, the natural fiber web is formed using an airlaid machine inline.

In at least one embodiment, the natural fiber web is formed using a carding machine inline or offline and prebonded by hydroentangling.

In at least one embodiment, the natural fiber web is a paper web formed by a paper making machine.

In at least one embodiment, the paper web is made of 100% wood pulp or a blend of natural fibers and wood pulp.

In at least one embodiment, the at least one spunbond or spunmelt web layer is made using polypropylene resin with round fiber cross-section.

In at least one embodiment, the at least one spunbond or spunmelt web layer is made using polypropylene resin with shaped cross-section. The shaped cross-section of the spunmelt filaments may allow for improved entrapment of the natural fibers in the composite structure.

In at least one embodiment, the at least one spunbond or spunmelt web layer is made using polypropylene resin with tri-lobal cross-section. The shaped cross-section of the spunmelt filaments may allow for improved entrapment of the natural fibers in the composite structure.

In at least one embodiment the at least one spunbond or spunmlet web layer is made using resin that comprises a blend of polypropylene, polypropylene-co-ethylene block copolymers and a slip aid.

In at least one embodiment, the composite structure is a patterned structure formed by the hydroentangling process or by calendering.

In at least one embodiment, the patterned structure is a three-dimensional structure.

In at least one embodiment, the three-dimensional structure is formed by an embossed steel or steel roll with patterns of greater than 1 micron depth.

In at least one embodiment, hand feel of the composite structure is enhanced by at least one of a brush roll mechanism, chemical surface peeling or the hydroentangling process.

In at least one embodiment, the composite structure comprises water based softener chemistries including but not limited to various ethylene and propylene based glycol surfactants and additives to enhance softness of the composite structure.

In at least one embodiment, the composite structure comprises water based hydrophobic additives to enhance hydrohead of the composite structure.

In at least one embodiment, the at least one nonwoven web layer comprises PLA to enhance some physical properties of the composite structure such as tenstile strength or stiffness or resilience

Other features and advantages of embodiments of the invention will become readily apparent from the following detailed description and the accompanying drawings.

### DESCRIPTION OF THE DRAWINGS

FIG. 1 is a cross-sectional view of a nonwoven composite web according to an exemplary embodiment of the present invention;

FIG. 2 is a block diagram illustrating a system for making a nonwoven composite web according to an exemplary embodiment of the present invention;

FIG. 3 is a block diagram illustrating a hydroentangling process with spunbond or spunmelt nonwoven web and natural fiber web according to an exemplary embodiment of the present invention; and

FIG. 4 is a block diagram illustrating a hydroentangling process with spunbond or spunmelt nonwoven web and natural fiber web according to an exemplary embodiment of the present invention.

FIG. 5 is a block diagram illustrating a hydroentangling process with spunbond or spunmelt nonwoven web and natural fiber web according to an exemplary embodiment of the present invention

FIG. 6 is a table of selective starting materials and process parameters for hydraulically entangling natural fiber containing composite fabrics in accordance with exemplary embodiments of the invention.

FIG. 7 is a table of results corresponding to FIG. 6.

FIGS. 8A and 8B are tables of material characteristic comparisons between existing products and between a sample resulting from a process according to an exemplary embodiment of the invention and an existing product, respectively.

FIGS. 9A and 9B are micrographs of a composite fabric that is hydraulically entangled under a set of process parameters and conditions reflected in FIG. 6 in accordance with an exemplary embodiment of the invention.

FIGS. 10A and 10B are micrographs of a composite fabrics that is hydraulically entangled under another set of process parameters and conditions reflected in FIG. 6 in accordance with an exemplary embodiment of the invention.

FIGS. 11A and 11B are micrographs of a composite fabrics that is hydraulically entangled under yet another set of process parameters and conditions reflected in FIG. 6 in accordance with an exemplary embodiment of the invention.

### DETAILED DESCRIPTION

The present invention is directed to the use of natural fibers, specifically cotton fiber with superior strength, abrasion resistance, tactile feel, and adjustable wettability characteristics for non-woven components of absorbent articles. In an exemplary embodiment, hydrophobic cotton fiber or slightly hydrophilic cotton fiber is used to produce non-woven diaper materials, such as top sheet and back sheet materials. A cotton fiber web is bonded to a spunbond or spunmelt nonwoven web layer by hydroentanglement to form a composite web structure that may be used to form a top sheet or back sheet of an absorbent article, or other absorbent article components that require at least some hydrophobicity.

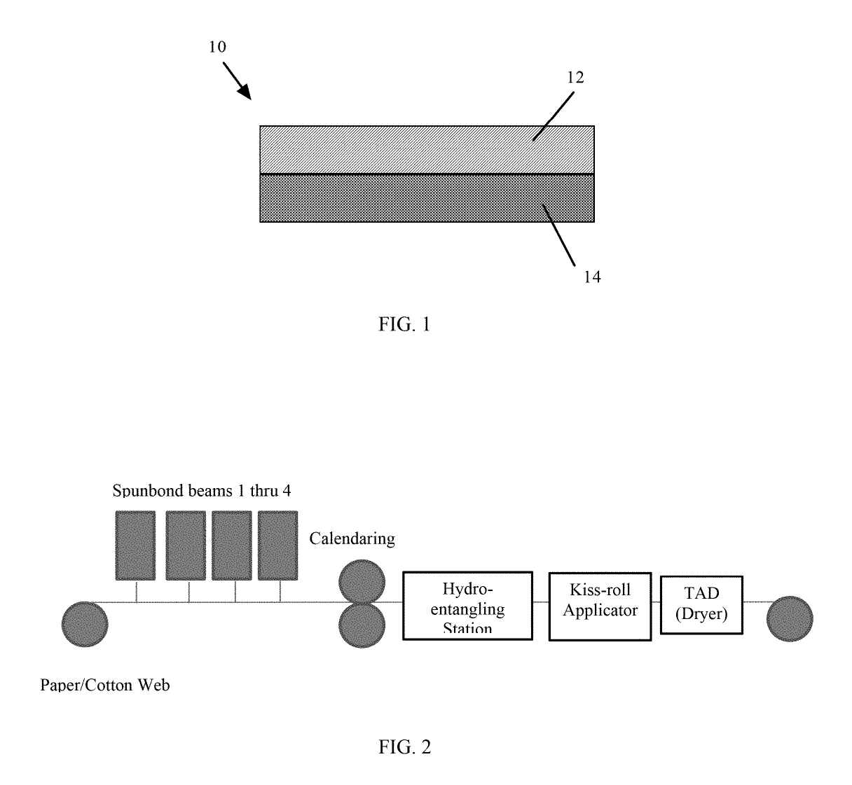

FIG. 1 is a cross sectional view of a composite web, generally designated by reference number 10, according to an exemplary embodiment of the present invention. The composite web 10 includes a natural fiber web layer 12 and a spunbond or spunmelt nonwoven web layer 14. The natural fiber web layer 12 is made of 0% to 100% processed natural fiber with hydrophobic or hydrophilic characteristics, such as, for example, abaca, coir, cotton, flax, hemp, jute, ramie, sisal, alpaca wool, angora wool, camel hair, cashmere, mohair, silk, wool, hardwood, softwood, elephant grass fibers, etc. Alternatively, the natural fiber web layer may be made of a blend of natural fibers and synthetic staple fibers. The nonwoven web layer 14 is a spunbond or spunmelt web made from thermoplastic polymers, such as, for example, polypropylene, polyethylene, polyester, nylon, PLA, etc. The layers 12 and 14 of the composite web 10 are bonded together by hydro-entangling. In exemplary embodiments, the composite web 10 may include more than one natural fiber web layer and/or more than one nonwoven web layer 14.

In a preferred exemplary embodiment, the natural fiber web layer 12 is made of cotton fiber. Cotton fiber is made up of cellulose, pectins, waxes and salts. Hydrophobic cotton is produced by taking controlled measures in the fiber processing step such as treating the cotton fiber with hydrophobic additives, washing the fiber to remove impurities but have the ability to trap naturally occurring wax, etc. This fiber processing step is done by the fiber manufacturer and the amount of hydrophobic additives added and level of fiber processing done to the natural fiber determines the degree of wettability characteristics. Such fibers with varied degree of wettability are available from natural fiber manufacturers. In exemplary embodiments of the present invention, such fibers are identified for use in forming a hydrophilic or hydrophobic non-woven composite web and the fiber wettability property is preserved during the hydroentangling process used to produce the composite web. In this regard, the hydrophobic characteristics of the processed natural fiber used to make the composite web 10 can be adjusted from slightly hydrophobic to fully hydrophobic. In exemplary embodiments of the invention, the natural fiber web layer 12 may comprise a blend of natural fibers, regenerated fibers, and synthetic staple fibers. Regenerated fibers may be cellulose-based fibers that are regenerated via solvent extraction or spinning—such as, viscose rayon, modified rayon fibers such as Tencel and the like.

In a preferred exemplary embodiment, the natural fiber web layer 12 is made of cotton fiber or wood pulp. Most commonly available hydrophilic cotton fibers from various fiber manufacturers can be used to make the natural fiber web. Conversely, unlike the previous embodiment, here the hydrophobic characteristic required for the composite web can be imparted post hydro-entangling at the kiss roll station via surface modification. Specifically, as shown in FIG. 2, the wet web coming out of the hydroentangling station passes through a kiss-roll applicator. At the kiss-roll applicator, several hydrophobic additives/surfactants such as wax emulsions, siloxane chemistries, fluorocarbons and other hydrocarbons can be applied to the web. The functional —OH groups present in the natural fiber web can react with the hydrophobic chemistries to form a permanent bond. This formed chemical linkage is cured at the through air drier. This method imparts durable hydrophobic properties to the composite web because the additive treatment is done post hydro-entangling step.

An additional surface finish, such as a softener can be applied to the composite web post hydro-entangling at the kiss roll station. For example, at the kiss-roll applicator, several silicone based softners, debonders etc., can be applied to the web to impart superior tactile feel. The functional —OH groups present in the natural fiber web can react with the softener chemistries to form a permanent bond. This formed chemical linkage formed is cured at the through air drier.

In another preferred exemplary embodiment, the natural fiber web layer 12 is made using a paper machine with both wood pulp and cotton linters. Hydrophobic and softness characteristics are imparted to the composite web post hydro-entangling station at the kiss roll applicator. For example, several surfactants that impart dual properties such as softness and hydrophobicity including but not limited to silicone based softeners, debonders, poly ethylene and propylene glycol based surfactants etc., can be applied to the web at the kiss roll applicator. The functional —OH groups present in the natural fiber web can react with the applied surface chemistry to form a permanent bond. This formed chemical linkage formed is cured at the through air drier.

The natural fiber web layer 12 can be produced using an airlaid machine inline, a carding machine inline or offline with prebonding via hydroentangling, or may be introduced as a paper web produced in a wetlaid machine. In the case of a paper web, the natural fiber web layer 12 may be made of 100% wood pulp, a blend of cotton and wood pulp or a blend of other natural fibers, such as hemp and wood pulp.

The spunbond or spunmelt web layer 14 may be produced using standard polypropylene resin with round fiber cross-section or shaped cross-sections, such as a tri-lobal fiber. The increased surface area of the shaped fiber assists in retaining the natural fibers in the composite web during the hydroentangling process. Alternatively, the spunbond or spunmelt web layer 14 is softer than a standard web and is produced by special formulations of resin including blends of polypropylene, polypropylene-co-ethylene block copolymers and a slip aid, such as erucamide.

The fluid pressure used to hydroentangle the two or more layers of the composite web 10 is within the range of 10 to 200 bars, and more preferably within the range of 20 to 100 bars. The hydroentangling energy flux target ranges between 0.05 to 1 Kw-hr/kg. The composite web 10 may be a patterned structure formed by the hydroentangling process or by calendering methods. In this regard, hydroentangling can create high density and low density natural fiber areas in the composite structure depending on the water pressure and water movement from jet to drum. The patterned structure can be a three-dimensional structure formed by the use of an embossed steel or steel roll with deep patterns greater than 1 micron depth.

In an exemplary embodiment, the composite web has a superior hand feel due to short fiber protrusions on the surface resulting from fuzzy finish. Fuzziness may be created by a brush roll mechanism, use of chemicals to create a surface peel or the hydroentangling process. To create free fibers/fuzz using the brush roll mechanism, the composite material is passed through a set of rolls that have fine bristles which produce loose fibers on the surface as it passes through. In the chemical surface peeling process, slightly alkaline or acidic solutions with the ability to swell/react with natural fibers are used to create loose fibers/fibrils on the surface. For the hydroentangling process, process conditions such as water jet pressure, choice of jet strip and/or wire mesh design on the suction boxes are adjusted to create vertical orientation of the short natural fibers. The level of fuzz is quantifiable using surface analysis tools such as optical microscope with surface topography measurement capabilities.

The composite web of the present invention has a durable and superior softness and slickness due to the natural fiber's ability to form covalent bonds with water based softener chemistries and surfactants. Use of natural fibers to make composite nonwoven material allows for further surface modification to the final web. Some specific end uses include use of water based surfactants and other chemistries to impart softness and or hydrophobicity to the product. For example, treatment of the natural fiber composite web with surfactants such as polyethylene glycol (PEG) provides a soft and slick yet durable finish, due to the covalent bond formation between natural fiber functional groups and hydroxyl groups of the PEG surfactant. Also, the strength properties of the natural fiber spunbond composite material can be enhanced when a thermoplastic material such as PLA is used to make the spunbond matrix. This strength increase is due to the reaction between the functional end groups in PLA and functional groups in natural fiber such as cotton, hemp, wood pulp, etc.

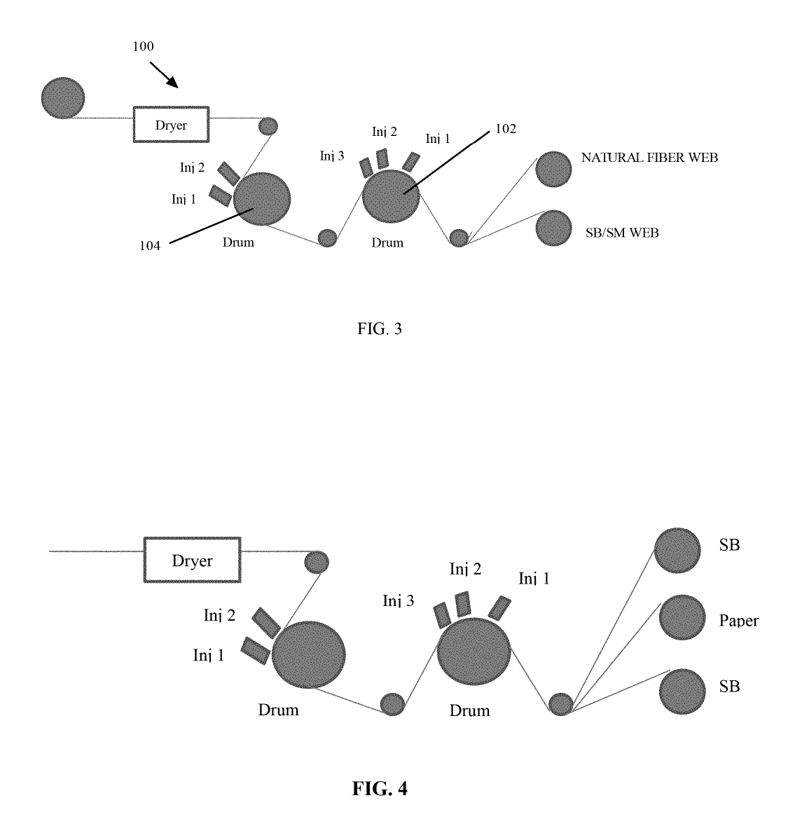

FIG. 3 shows a hydroentangling apparatus, general designated by reference number 100, according to an exemplary embodiment of the present invention. A natural fiber web and a spunbond or spunmelt web are fed to the hydroentangling apparatus 100 where they are layered together and subsequently fed to drums 102 and 104. The natural fiber web is formed as a paper web prior to delivery to the hydroentangling apparatus 100 by, for example, a through air drying (TAD) machine or by an offline carding machine with prebonding. Alternatively, the natural fiber web may be formed inline using an airlaid or carding machine. As the layered structure passes over the drums 102, 104, manifolds surrounding the drums 102, 104 generate water jets so as to hydroentangle the layered structure in a multi-step hydroentanlging process. The hydroentangling process results in the formation of a composite web structure made up of a natural fiber web layer and a spunbond or spunmelt layer. It should be appreciated that the final product may include any number of both natural fiber web layers and spunmelt or spunbond layers arranged in any sequence.

The following examples are illustrative of various features and advantages of the present invention.

### Example 1: Method to Produce a Patterned Composite Web by Hydroentangling a Preformed Cotton Web and Spunbond Web

A 25 gsm 50:50% cotton: staple polypropylene fiber carded web was made using a Trutzschler carded spunlace line (Trutzschler GmbH & Co. KG, Mönchengladbach, Germany). HE energy levels used to pre-entangle the carded web was at 20, 30, 40 bars from the 3 injection manifolds of drum 1 and 60, 60 bars from the injection manifolds of drum 2, respectively as shown in FIG. 3. As the next step to make the composite web, a 12 gsm spunbond polypropylene web was hydroentangled with the preformed carded web to produce a composite web using the same Trutzschler carded spunlace line. Energy levels used to hydroentangle the spunbond and carded webs were at 20, 80, 80 bars from the 3 injection manifolds of drum 1 and 100, 100 bars from the injection manifolds of drum 2, respectively.

### Example 2: Method to Produce a Patterned Composite Web by Hydroentangling a Preformed Cotton Web and 2 Spunbond Webs

A 25 gsm 100% cotton fiber carded web was made using a Trutzschler carded spunlace line. HE energy levels used to pre-entangle the carded web was at 20, 30, 40 bars from the 3 injection manifolds of drum 1 and 60, 60 bars from the injection manifolds of drum 2, respectively as shown in FIG. 3. As the next step to make the composite web, two identical 12 gsm spunbond polypropylene webs were hydroentangled with the preformed carded web to produce a three layer composite web using the same Trutzschler carded spunlace line. Energy levels used to hydroentangle the spunbond and carded webs were at 20, 80, 80 bars from the 3 injection manifolds of drum 1 and 100, 100 bars from the injection manifolds of drum 2, respectively.

### Example 3: Method to Produce a Patterned Composite Web by Hydroentangling Paper and Spunbond Webs at Low Energy

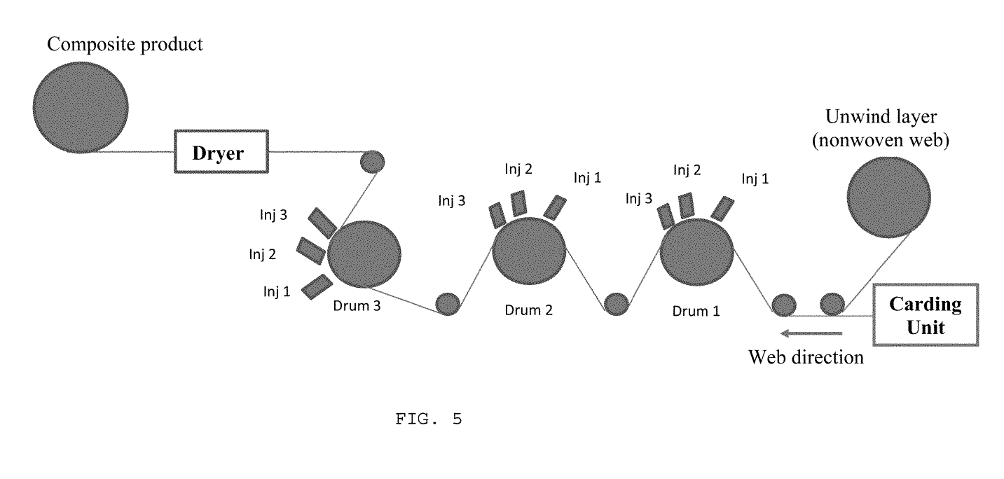

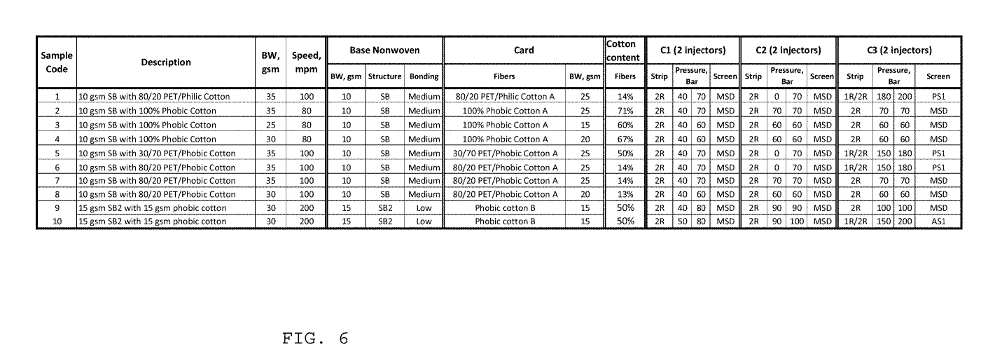

A patterned/structured paper web was made using a TAD paper machine. The paper web had permanent wet strength Kymene™ 821 (PAE resin) available from Hercules Incorporated, Wilmington, Del., USA, at add-on levels of at least 6 kg/ton. The patterned structured web was then hydroentangled with two 12 gsm polypropylene spunbond webs. The patterned structure of the paper web was preserved in the composite non-woven fabric by using a low HE energy intensity during the hydroentangling process. HE energy conditions were 20, 40, 40 bars from the three injection manifolds of drum 1 and 40, 40 bars from the two injection manifolds of drum 2, as shown in FIG. 4.

### Example 4: Method to Produce a Flat Composite Web by Hydroentangling Paper and Spunbond Webs at High HE Energy

Two identical spunbond polypropylene webs with basis weight of 12 gsm each and a gsm paper web used to make paper towel were hydroentangled together to make a composite non-woven fabric. FIG. 4 shows the web arrangement with the paper web sandwiched between the two spunbond webs.

The patterned/structured paper web was made using a TAD paper machine. The paper web had permanent wet strength Kymene 821 (PAE resin) at add-on levels of at least 6 kg/ton. High HE energy levels was used to entangle the two SB and paper web at 20, 100, 100 bars from the three injection manifolds of drum 1 and 150, 150 bars from the two injection manifolds of drum 2, as shown in FIG. 4. Due to the use of high HE energy levels, the patterned paper web structure was disrupted and lost during the process resulting in flat but strong composite non-woven material.

The present invention is further described with reference to the following additional examples with a variety of natural fiber raw materials and process conditions, but it should be construed that the present invention is in no way limited to those examples.

FIG. 5, for example, illustrates a hydroentangling apparatus according to another exemplary embodiment of the present invention. A natural fiber web may be formed by a carding machine (or “unit”) and a spunbond or spunmelt web may be unwound before being fed to the hydroentangling apparatus where the webs are layered together and subsequently fed to drums (Drum 1, Drum 2, and Drum 3) with respective water injectors (Inj 1, Inj 2, and Inj 3). The hydroentangled web layers may then be dried to form the composite product.

Test methods used to determine fabric properties described in the examples were measured by the following methods.

Strike-Through Test Method

A test method that measures the rate of penetration of a 5 mL volume of 0.9% sodium chloride based saline solution (simulated urine) into a nonwoven that is placed upon five-layers of absorbent paper. Industry standard Lister strikethrough test equipment was used for this test. Hydrophilicity drives strike-through times. Lower strike-through values typically indicate a more hydrophilic material. Typical strike-through values for a nonwoven used in a diaper top-sheet are 2-3 seconds.

The test procedure includes the following steps:
1.1. Set 10 plies of Ahlstrom Grade 989 strikethrough filter paper smooth side facing upwards, on the acrylic base plate.
1.2. Place a 10 cm×10 cm sample—smooth side facing upwards—on top of the filter paper.
1.3. Set the strikethrough plate on top of the prepared samples.
1.4. Position the assembled sample and equipment on the testing base in a way that it is centered underneath the funnel.
1.5. Dispense 5 ml of sodium chloride into the funnel.
1.6. Press the start button located on the left hand side of the Lister to release liquid onto the sample.
1.7. When all of the liquid has passed through the electrodes of the strikethrough plate, the Lister timer will stop.
1.8. Record the time displayed on the Lister and report as the first strikethrough time.

Rewet Test Method

A test method that assess a nonwoven's tendency to retain the insult fluid during a strike-through test. This test is especially used on a top-sheet where the function is to rapidly pull the insult through it and allow it to transfer through the acquisition layer to the absorbent core. If a nonwoven is too absorbent, it will retain some of the insult fluid instead of allowing it to transfer to the core. This causes a high re-wet value. Typically, for a diaper topsheet application the goal is to have fast strike-through times with low re-wet values since a nonwoven with a high re-wet value will retain the insult fluid and stay wet which is not good for skin contact. The re-wet is measured by insulting the nonwoven with a larger volume of 0.9% saline solution and then placing pre-weighed paper on top of the wetted nonwoven. A weight is placed on top of the paper to simulate a baby sitting on the wet top-sheet. After a period of time the weight is removed and the paper is weighed again. Fluid that was retained in the nonwoven is pulled into the paper and its mass is recorded. Typical re-wet values are ˜0.15 g.

The test procedure includes the following steps, which is to be performed after completing the single strike through test described above.
a. Weigh 2 pieces of the wetback paper. The mass should be recorded in grams to the nearest 0.01 gram. Record this mass as “weight before”.
b. Slide the plastic tray w/ the filter paper and nonwoven specimen into the Wetback tester.
c. Push the “WET” button. (weight will lower and remain in place for 3 minutes)
d. After 3 minutes, place the 2 pieces of wetback paper directly on top of the nonwoven sample.
e. Push the “REWET” button. (weight will lower and remain in place for 2 minutes)
f. After 2 minutes, remove and weigh the 2 pieces of rewet paper. Mass should be recorded in grams to the nearest 0.01 gram. Record this mass as “weight after”.
Note: Rewet paper should be weighed immediately after removing the baby weight. If not, the liquid will evaporate.
g. Calculate the rewet value (g): rewet=weight after−weight before

Handle-O-Meter Test Method

The Handle-O-Meter (HOM) stiffness of nonwoven materials is performed in accordance with WSP test method 90.3 with a slight modification. The quality of “hand” is considered to be the combination of resistance due to the surface friction and flexural rigidity of a sheet material. The equipment used for this test method is available from Thwing Albert Instrument Co., In this test method, a 100×100 mm sample was used for the HOM measurement and the final readings obtained were reported “as is” in grams instead of doubling the readings per the WSP test method 90.3. Average HOM was obtained by taking the average of MD and CD HOM values. Typically, lower the HOM values higher the softness and flexibility, while higher HOM values means lower softness and flexibility of the nonwoven fabric.

Tensile Strength Measurement Method

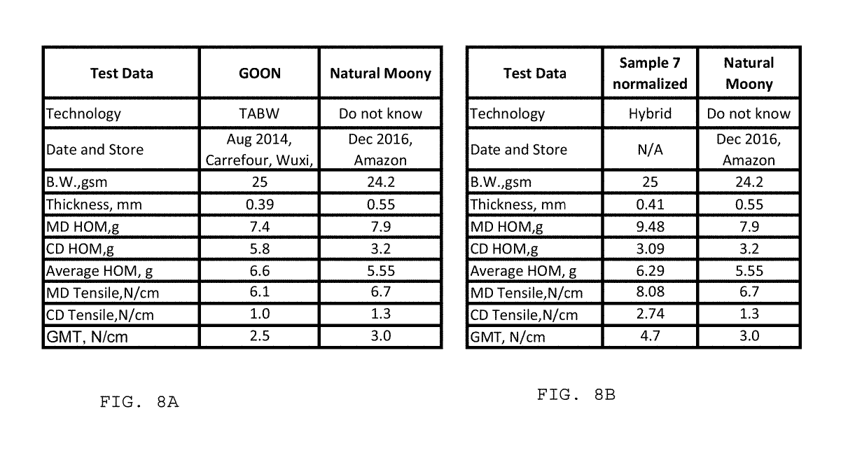

Tensile strength measurement is performed in accordance with either ASTM or WSP methods, more specifically ASTM D5035 or WSP 110.4(05)B, using an Instron test machine. Measurement is done in both MD and CD directions respectively. MD strength and elongation, CD strength and elongation, along with geometric mean tensile strength (GMT), which is the square root of the product of MD and CD strength are reported in the results table, FIG. 7.

Other reported properties such as air permeability and thickness measurements were determined in accordance with ASTM or INDA standard test methods.

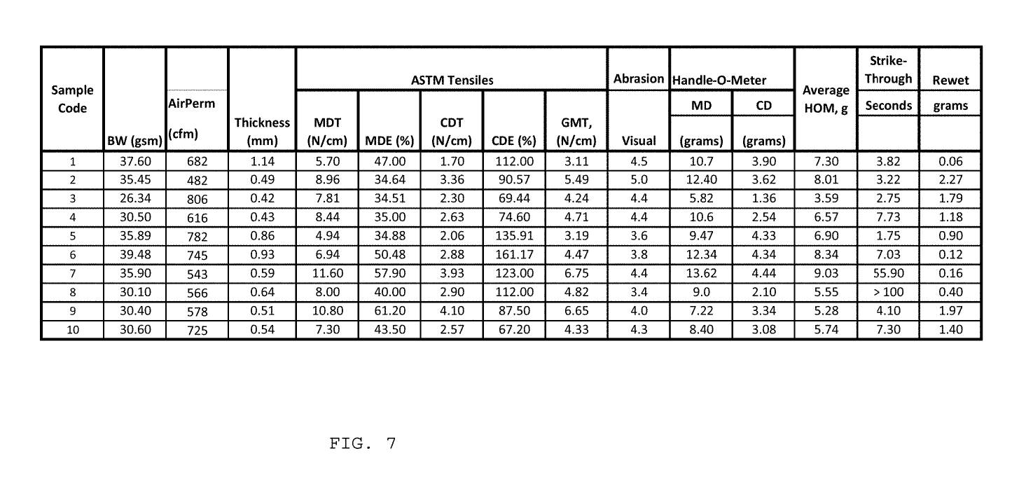

As shown in FIG. 6, the materials used for the respective trials (corresponding to respective “Sample Codes” in FIGS. 6 and 7), which include 10 gsm and 15 gsm spunbond nonwoven fabrics bonded with low and medium bonding conditions, and hydroentangled with blended philic cotton A, pure and blended phobic cotton A, and phobic cotton B, respectively.

Low bonding conditions comprise an engraved-roll temperature of 145° C., smooth-roll temperature of 145° C. and calender pressure of 30 N/mm.

Medium bonding conditions comprise an engraved-roll temperature of 150° C., smooth-roll temperature of 150° C. and calender pressure of 30 N/mm.

In addition, as reflected in the Table of FIG. 6, the strips and screens used with the water injector sets (C1, C2, and C3) for hydraulically entangling the nonwovens are as follows:

Strip: 1R:—a metal strip perforated with one row of very small holes across its width from which the high pressure water flows creating water needles that hit the nonwoven and carded web and entangle the fibers together.

Strip: 2R:—a metal strip perforated with two rows of very small holes across its width from which the high pressure water flows creating water needles that hit the nonwoven and carded web and entangle the fibers together.

Screen—MSD: a metal sleeve that fits over the drum in the hydraulic jet-lace unit against which the hydraulic water needles are applied to the material. 100 holes/cm2 which are 300 microns in diameter. 8% open-area.

Screen—PS1: a metal sleeve with a matrix of holes which allows for the creation of a pattern into the nonwoven based on water flow through the screen—with an average hole diameter of 3 mm.

Screen—AS1: a metal sleeve with a matrix of holes which allows for the creation of a aperture hole into the nonwoven based on water flow through the screen—the average aperture size being 0.9 mm×1.5 mm, MD×CD.

The results shown in FIG. 7 relate to cotton fiber based spunbond composite fabrics. The parameters include a resulting basis weight (BW) is gsm (grams per square meter), AirPerm (air permeability) in cfm (cubic feet per minute), thickness, MDT (machine direction tensile strength) in N/cm (Newtons per centimeter), MDE (machine direction elongation) in %, CDT (cross machine direction tensile strength) in N/cm (Newtons per centimeter), CDE (cross direction elongation) in %, GMT (Geometric mean tensile strength) in N/cm:—which is the square root of the product of MDT and CDT, MD HOM (machine direction Handle-O-Meter) in grams (g), CD HOM (cross machine direction Handle-O-Meter), Avg HOM (average Handle-O-Meter), “visual” abrasion resistance, and strike-through and rewet tests.

The “visual” abrasion rating resistance parameter refers to a NuMartindale Abrasion measure of the abrasion resistance of the surface of a fabric sample and is performed in accordance with ASTM D 4966-98, which is hereby incorporated by reference. The NuMartindale Abrasion test was performed on each sample with a Martindale Abrasion and Pilling Tester by performing 40 to 80 abrasion cycles for each sample. Testing results were reported after all abrasion cycles were completed or destruction of the test sample. Preferably, there should be no visual change to the surface of the material.

For each sample, following NuMartindale Abrasion, an abrasion rating was determined based on a visual rating scale of 1 to 5, with the scale defined as follows:

5=excellent=very low to zero fibers removed from the structure.
4=very good=low levels of fibers that may be in the form of pills or small strings.
3=fair=medium levels of fibers and large strings or multiple strings.
2=poor=high levels of loose strings that could be removed easily.
1=very poor=significant structure failure, a hole, large loose strings easily removed.

### Example 5: Method to Produce a Cotton Containing Nonwoven Fabric

An exemplary embodiment of the present invention, Sample #1 (“Sample Code” in FIGS. 6 and 7), wherein the 10 gsm spunbond nonwoven was produced in a 3 beam spunbond process, laying down three layers of fibers using ExxonMobil 3155 polypropylene. The 3 layer spunbond was exposed to medium bonding conditions using a standard oval bond roll, with ˜18% land area. The resulting 10 gsm spunbond web was unwound on a spunlace line as shown in FIG. 5 where it was combined with a 20 gsm carded nonwoven web containing discontinuous fibers made of 80 and 20% polyester and philic cotton fibers, respectively. The polyester fiber is a standard staple fiber with 1.5 to 2 denier per filament, 38 mm fiber length. Fiber length of philic cotton fiber A is typically in the range of 20 to 25 mm and can be purchased from several cotton suppliers. The process conditions to combine the carded and spunbond web are shown in FIG. 6. As shown in FIG. 6, the process conditions for Sample #1 include: exposing the combined web to C1 (water) 2R injectors at 40 and 70 bars over a MSD screen, C2 2R injectors (subset) at 70 bars over a MSD screen, and C3 1R/2R injectors at 180 and 200 bars, respectively, over a PS1 screen. Additionally, a patterning sleeve PS1 was used in the 3^{rd} drum to create a patterned composite web. The resulting fabric has approximately 14% cotton content, with very good tensile strength of GMT=3.11 N/cm and excellent abrasion resistance of 4.5 visual rating as shown in FIG. 7. The excellent abrasion resistance ratings indicate very good fiber tie-down of both the cotton and polyester fiber to the base spunbond web.

### Example 6: Method to Produce a Cotton Containing Nonwoven Fabric

An exemplary embodiment of the present invention, Sample #2 (“Sample Code” in FIGS. 6 and 7), wherein the 10 gsm spunbond nonwoven was produced in a 3 beam spunbond process, laying down three layers of fibers using ExxonMobil 3155 polypropylene. The 3 layer spunbond was exposed to medium bonding conditions using a standard oval bond roll, with 18% land area. The resulting 10 gsm spunbond web was unwound on a spunlace line as shown in FIG. 5, where it was combined with a 20 gsm carded nonwoven web containing discontinuous fibers made of 100% phobic cotton fibers. Fiber length of phobic cotton fiber A is typically in the range of 20 to 25 mm and can be purchased from several cotton suppliers. The process conditions to combine the carded and spunbond web are shown in FIG. 6. A detailed description of the process conditions for Sample #2 shown in FIG. 6 will not be repeated as they correspond to those of Sample #1 in Example 5 above but with different values for the respective parameters. The resulting fabric has approximately 71% cotton content, with excellent tensile strength of GMT=5.49 N/cm and an excellent abrasion resistance of 5 visual rating as shown in FIG. 7. The excellent abrasion resistance ratings indicate very good fiber tie-down.

### Example 7: Method to Produce a Cotton Containing Nonwoven Fabric

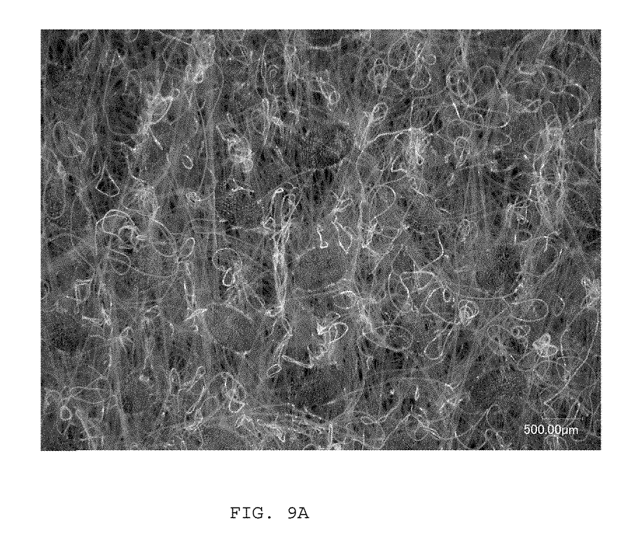

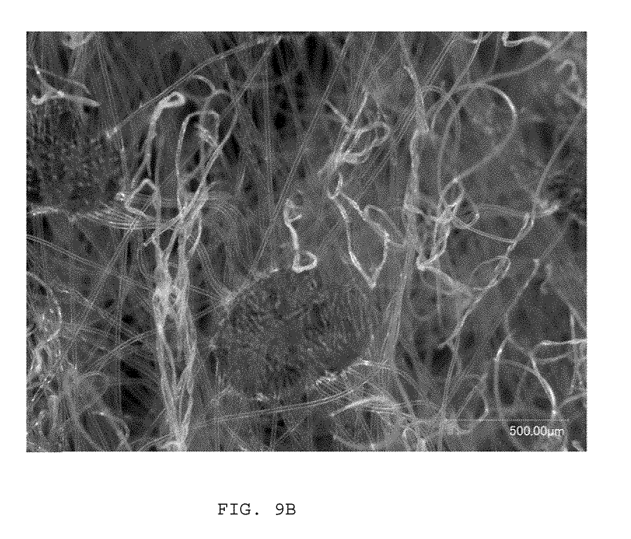

An exemplary embodiment of the present invention, Sample #3, wherein the 10 gsm spunbond nonwoven was produced in a 3 beam spunbond process, laying down three layers of fibers using ExxonMobil 3155 polypropylene. The 3 layer spunbond was exposed to medium bonding conditions using a standard oval bond roll, with 18% land area. The resulting 10 gsm spunbond web was unwound on a spunlace line as shown in FIG. 5, where it was combined with a 15 gsm carded nonwoven web containing discontinuous fibers made of 100% phobic cotton fibers. Fiber length of phobic cotton fiber A is typically in the range of 20 to 25 mm and can be purchased from several cotton suppliers. The process conditions to combine the carded and spunbond web are shown in FIG. 6. A detailed description of the process conditions for Sample #3 shown in FIG. 6 will not be repeated as they correspond to those of Sample #1 in Example 5 above but with different values for the respective parameters. The resulting fabric has approximately 60% cotton content, with very good tensile strength of GMT=4.24 N/cm and excellent abrasion resistance of 4.4 visual rating, as shown in FIG. 7. Additionally the average HOM data of 3.59 grams indicates excellent hand feel and fabric flexibility. In general, HOM is a measure of softness and lower the test value in grams, higher the softness. In this example, it is to be noted that the average HOM values obtained are even better than the competitive product HOMs shown in FIG. 8A.

### Example 8: Method to Produce a Cotton Containing Nonwoven Fabric

An exemplary embodiment of the present invention, Sample #7, wherein the 10 gsm spunbond nonwoven was produced in a 3 beam spunbond process, laying down three layers of fibers using ExxonMobil 3155 polypropylene. The 3 layer spunbond was exposed to medium bonding conditions using a standard oval bond roll, with 18% land area. The resulting 10 gsm spunbond web was unwound on a spunlace line as shown in FIG. 5, where it was combined with a 25 gsm carded nonwoven web containing discontinuous fibers made of 80 and 20% polyester and phobic cotton fibers, respectively. The polyester fiber is a standard staple fiber with 1.5 to 2 denier per filament, 38 mm fiber length. Fiber length of phobic cotton fiber A is typically in the range of 20 to 25 mm and can be purchased from several cotton suppliers. The process conditions to combine the carded and spunbond web are shown in FIG. 6. A detailed description of the process conditions for Sample #7 shown in FIG. 6 will not be repeated as they correspond to those of Sample #1 in Example 5 above but with different values for the respective parameters. The resulting fabric has approximately 14% cotton content, with very good tensile strength of GMT=6.75 N/cm and excellent abrasion resistance of 4.4 visual rating as shown in FIG. 7. The excellent abrasion resistance ratings indicate very good fiber tie-down of both the cotton and polyester fiber to the base spunbond web.

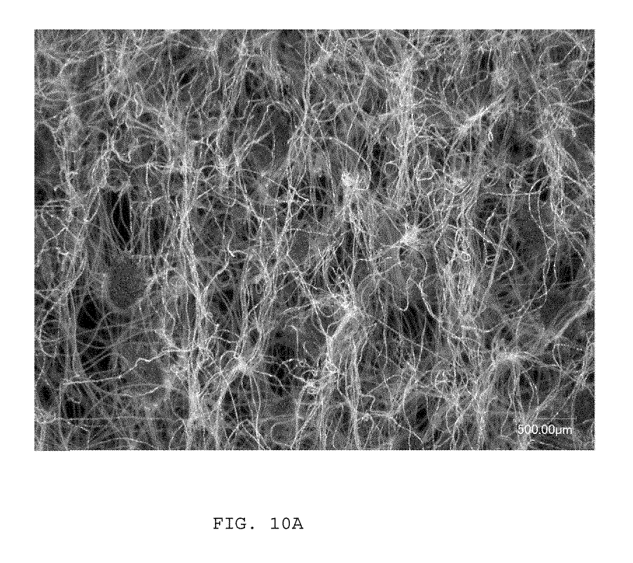

FIGS. 9A and 9B are micrographs of a Sample #7 composite fabric, FIG. 9B being a higher magnification micrograph. From these figures, it is observed that the bond pattern used in the primary nonwoven web is still intact.

### Example 9: Method to Produce a Cotton Containing Nonwoven Fabric

An exemplary embodiment of the present invention, Sample #9, wherein a 15 gsm spunbond nonwoven was produced in a 4 beam spunbond process, laying down four layers of fibers using ExxonMobil 3155 polypropylene. The 4 layer spunbond was exposed to low bonding conditions using a standard oval bond roll, with 18% land area. The resulting 15 gsm spunbond web was unwound on a spunlace line as shown in FIG. 5, where it was combined with a 15 gsm carded nonwoven web containing discontinuous fibers made of 100% phobic cotton fibers. Fiber length of phobic cotton fiber B is typically in the range of 20 to 25 mm and can be purchased from several cotton suppliers. The process conditions to combine the carded and spunbond web are shown in FIG. 6. A detailed description of the process conditions for Sample #9 shown in FIG. 6 will not be repeated as they correspond to those of Sample #1 in Example 5 above but with different values for the respective parameters. The resulting fabric has approximately 50% cotton content, with very good tensile strength of GMT=6.65 N/cm and excellent abrasion resistance of 4.0 visual rating as shown in FIG. 7. Additionally the average HOM data of 5.28 grams indicates excellent hand feel and fabric flexibility. In general, HOM is a measure of softness and lower the test value in grams, higher the softness.

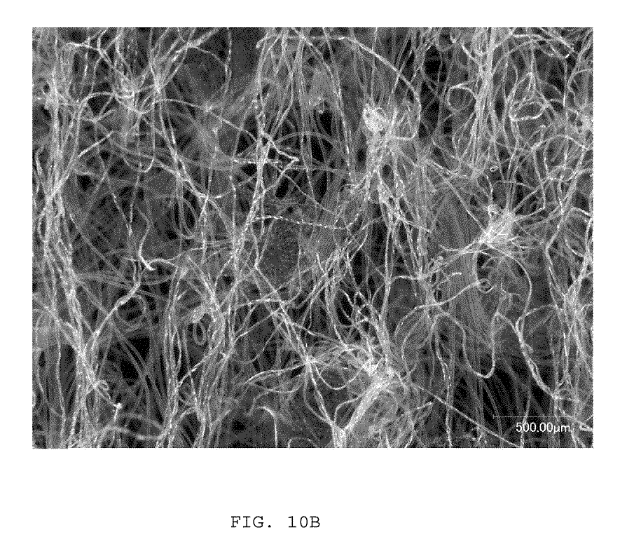

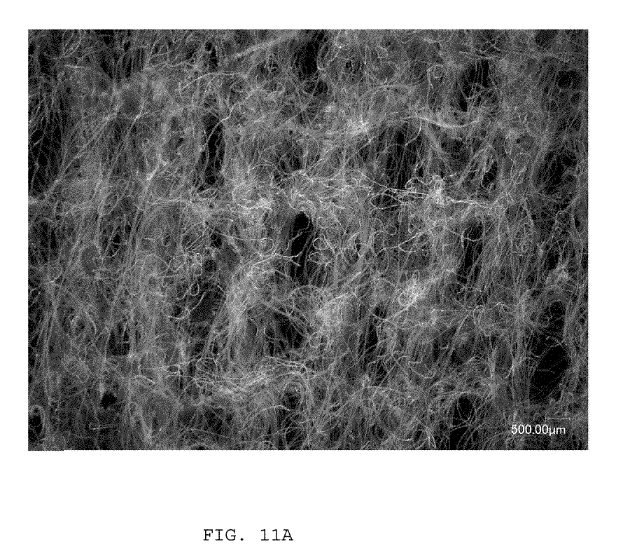

FIGS. 10A and 10B are micrographs of a Sample #9 composite fabric, FIG. 10B being a higher magnification micrograph.

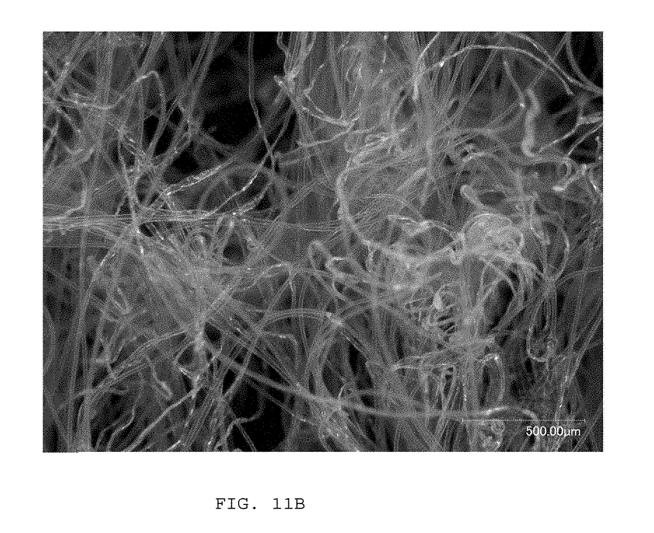

FIGS. 11A and 11B are micrographs of a Sample #10 composite fabric. FIG. 11B being a higher magnification micrograph. As shown in FIGS. 11A and 11B, a pattern in the composite fabric can be discerned resulting from a water injection step over an apertured screen AS1, as reflected in the Table of FIG. 6.

### Example 10: Method to Produce a Cotton Containing Nonwoven Fabric with Adjustable Wettability Characteristics

It is observed from FIG. 7 that the wettability characteristics can be varied significantly by changing the cotton fiber choice, blend proportion, basis weight, patterning effects etc. More specifically, the fiber choice is very important for topsheet wettability characteristics, which is monitored in terms of strike through and rewet properties. Higher water strike-through and lower rewet properties indicate that the fabric is hydrophobic, while lower strike through and higher rewet properties indicate the fabric is hydrophilic. As shown in FIG. 7, the strike through properties range from 1.8 seconds to greater than 100 seconds, while the rewet properties ranges from 0.06 grams to 2.27 grams. Additionally the wettability characteristics can be changed further by treating the composite web with small amounts of topical philic surfactants. Sample #8, which had high strike through >100 seconds was modified with a small amount of topical philic surfactant and the resulting treated fabric had a strike through of 0.5 seconds with little to no effect on the rewet properties.

FIGS. 8A and 8B show physical testing data of competitive products available in the market for benchmarking a composite fabric made in accordance with an exemplary embodiment of the invention for both diaper topsheet and backsheet applications. The Goon product is believed to be produced using carded through air bonded (TABW) technology and apparently does not contain any cotton. Production technology for the “Natural Moony” product is unknown, it is believed to be a carding-based technology combined with either hydroentangling or through air bonding. The “Natural Moony” topsheet obtained from the diaper is believed to contain cotton fibers and is likely in the 5 to 15% cotton content range. The Goon product data listed on the table in FIG. 8A is from the diaper backsheet, which was carefully removed from the diaper to test for physical properties. In the case of “Natural Moony,” the data listed on the table in FIG. 8A is from the diaper “topsheet,” which was carefully removed from the diaper to test for physical properties. As seen from FIGS. 8A and 8B, it can be inferred that the typical GMT strength of such products are at or below 3 N/cm.

### Comparative Example 1

Sample 7 shown in FIGS. 6 and 7 was normalized to 25 gsm basis weight for comparative purposes. The resultant sample 7 normalized data is shown in FIG. 8B along with competitive topsheet data obtained from cotton containing “Natural Moony” product. As shown in FIG. 8B, it is observed that the Sample 7 “normalized” has significantly higher GMT strength of 4.7 N/cm versus 3.0 N/cm at comparable CD HOM values. This higher strength similar to other examples explained before leads to superior fiber tie-down and therefore very good to excellent abrasion properties.

While in the foregoing specification a detailed description of a specific embodiment of the invention was set forth, it will be understood that many of the details herein given may be varied considerably by those skilled in the art without departing from the spirit and scope of the invention.

1. A composite fabric, comprising:
one or more nonwoven web layers;
one or more natural fiber web layers incorporated with the one or more nonwoven web layers by a plurality of hydroentangling steps, wherein
said composite fabric has a GMT (geometric mean tensile strength) of at least 3.1 N/cm (Newton per centimeter).

2. The composite fabric of claim 1, wherein the one or more nonwoven web layers comprise one or more of a spunbond web layer and a spunmelt web layer.

3. The composite fabric of claim 2, wherein the one or more nonwoven web layers comprise a philic in-melt additive.

4. The composite fabric of claim 2, wherein the one or more nonwoven web layers comprise polypropylene, polyethylene, polyester, nylon, or PLA (polyactic acid).

5. The composite fabric of claim 1, wherein the one or more natural fiber web layers comprise one or more of a carded web and a pre-formed web containing natural fibers.

6. The composite fabric of claim 5, wherein the one or more natural fiber web layers comprise adjustable wettability characteristics by natural fiber bonding to one or more additives.

7. The composite fabric of claim 6, wherein at least one natural fiber web layer is completely hydrophobic.

8. The composite fabric of claim 6, wherein at least one natural fiber web layer is completely hydrophilic.

9. The composite fabric of claim 6, wherein at least one natural fiber web layer is adjusted to be at least partially hydrophobic.

10. The composite fabric of claim 1, wherein the one or more natural fiber web layers comprise at least one of abaca, coir, cotton, flax, hemp, jute, ramie, sisal, alpaca wool, angora wool, camel hair, cashmere, mohair, silk, wool, hardwood, softwood, or elephant grass fibers.

11. The composite fabric of claim 1, wherein the one or more natural fiber web layers comprise cotton fibers and/or cotton linters.

12. The composite fabric of claim 11, wherein overall cotton content is between about 1% and 80%.

13. The composite fabric of claim 12, wherein the overall cotton content is between about 4% and 55%.

14. The composite fabric of claim 1, wherein the one or more natural fiber web layers comprise pulp fibers, hardwood and/or softwood fibers.

15. The composite fabric of claim 1, wherein the one or more natural fiber web layers comprise a blend of natural fibers, regenerated fibers, and synthetic staple fibers.

16. The composite fabric of claim 1, wherein the one or more natural fiber layers are incorporated at a basis weight of about 10 to 40 gsm (grams per square meter) for a total basis weight of about 20 to 100 gsm for the composite fabric.

17. The composite fabric of claim 1, wherein said composite fabric has a visual abrasion rating of at least 3.0.

18. The composite fabric of claim 1, wherein the plurality of hydroentangling steps comprise at least two water injection steps of exposing said bonded web layers to a plurality of water jets over respective drums.

19. The composite fabric of claim 1, wherein the plurality of hydroentangling steps comprise:
a first water injection step of exposing said bonded web layers to a plurality of water jets at a first pressure range of about 40-120 bars;
a second water injection step of exposing said bonded web layers to a plurality of water jets at a second pressure range of about 60-150 bars; and
a third water injection step of exposing said bonded web layers to a plurality of water jets at a third pressure range of about 60-250 bars.

20. The composite fabric of claim 1, wherein the one or more nonwoven web layers are thermally bonded by an engraved roll, at a temperature range of 120 to 170° C., and a smooth roll, at a temperature range of 120 to 170° C., having a calender nip pressure range of 20 to 150 N/mm.

21. A process of manufacturing a composite fabric, comprising:
pre-bonding nonwoven fibers to form one or more nonwoven web layers;
bonding one or more natural fiber web layers to the one or more nonwoven web layers;
hydraulically entangling the bonded one or more nonwoven web layers and one or more natural fiber web layers by a plurality of steps of water injection, each over a corresponding screen having a respective predetermined pattern, said plurality of water injection steps comprising:
a first water injection step of exposing said bonded web layers to a plurality of water jets at a first pressure range of about 40-120 bars;
a second water injection step of exposing said bonded web layers to a plurality of water jets at a second pressure range of about 60-150 bars; and
a third water injection step of exposing said bonded web layers to a plurality of water jets at a third pressure range of about 60-250 bars.

22. The process of claim 21, wherein one or more of said first water injection step and said third water injection step comprises maintaining at least two subsets of said plurality of water jets at different pressures.

23. The process of claim 21, wherein the one or more natural fiber web layers comprise a preformed web in the form of a rolled good that is unwound for said bonding step.

24. The process of claim 23, wherein the rolled good includes 100% wood fibers.

25. The process of claim 23, wherein the rolled good includes 100% cotton fibers.

26. The process of claim 23, wherein the rolled good comprises a combination of wood fibers and cotton fibers.

27. The process of claim 21, wherein the one or more natural fiber web layers comprise a blend of natural fibers and synthetic staple fibers having natural fiber content between about 5% and 80%.

28. The process of claim 21, wherein the one or more natural fiber layers are incorporated at a basis weight of about 10 to 40 gsm (grams per square meter) for a total basis weight of about 20 to 100 gsm for said bonded web layers.

29. The process of claim 21, wherein the plurality of steps of water injection comprises patterning the bonded web layers in accordance with one or more of the corresponding screens.

30. The process of claim 21, wherein the plurality of steps of water injection comprises a target hydroentangling energy flux range of 0.05 to 1 Kw-hr/kg.

31. The process of claim 21, wherein the one or more natural fiber web layers comprise a hydrophilic natural fiber.

32. The process of claim 21, wherein the one or more natural fiber web layers are formed using an airlaid machine inline.

33. The process of claim 21, wherein the one or more natural fiber web layers are formed using a carding machine inline or offline and prebonded by hydroentangling.

34. The process of claim 21, wherein the one or more natural fiber web layers comprise a paper web formed by a paper.

35. The process of claim 34, wherein the paper web is made of 100% wood pulp or a blend of natural fibers and wood pulp.

36. The process of claim 21, wherein the one or more nonwoven web layers comprise at least one spunbond or spunmelt web layer made using a resin that comprises a blend of polypropylene, polypropylene-co-ethylene block copolymers, and a slip aid.

37. The process of claim 21, further comprising applying water-based softener chemistries to said bonded web layers.

38. The process of claim 37, wherein the water-based softener chemistries comprises one or more of ethylene and propylene-based glycol surfactants and additives.

39. The process of claim 21, further comprising applying water-based hydrophobic additives to said bonded web layers.

40. An absorbent article, comprising:
a topsheet; and
a backsheet,
wherein at least one of said topsheet and said backsheet is formed by a composite fabric, comprising:
one or more nonwoven web layers; and
one or more natural fiber web layers incorporated with the one or more nonwoven web layers by a plurality of hydroentangling steps, and
wherein said composite fabric has a GMT (geometric mean tensile strength) of at least 3.1 N/cm (Newton per centimeter).
